(19) United States
(12) Patent Application Publication
(10) Pub. No.: US 2006/0286517 A1
(43) Pub. Date: Dec. 21, 2006

(54) VIDEO JOB ANALYSIS SYSTEM

(76) Inventors: Brian Matthew Martin, Corona, CA (US); Gregg L. Bernhard, Corona, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/425,563

(22) Filed: Jun. 21, 2006

Related U.S. Application Data
(60) Provisional application No. 60/692,674, filed on Jun. 21, 2005.

(51) Int. Cl. G09B 19/00

(52) U.S. Cl. 434/219

(57) ABSTRACT

A job analysis database, wherein the database includes video and narrative data indicative of job functions of at least one job. The video and narrative data is subdivided and indexed by job function such that at least one user can access one or more portions of the video and narrative data corresponding to job functions of interest. The database can be remotely accessed to allow multiple users to easily gain secured access to the job function data to facilitate access to more current and relevant information and/or to update the information. A system providing job analysis data wherein the data includes video illustrations of job tasks and associated narrative description of the job tasks for at least a first job and wherein one or more authorized users can input additional narrative for the at least first job such that the additional narrative is accessible by other authorized users.

### CROSS-REFERENCE TO RELATED APPLICATIONS

This application claims the priority benefits of U.S. Provisional Application 60/692,674 filed Jun. 21, 2005 which is incorporated herein in its entirety by reference.

### BACKGROUND OF THE INVENTION

1. Field of the Invention

The invention relates to the field of job analysis and to a system whereby interested parties can easily access job analysis data.

2. Description of the Related Art

A description of the essential job functions and responsibilities for a given job or position is a legal requirement in many jurisdictions. Job analysis refers to a process of analyzing a particular job and providing a corresponding description of the associated job requirements and quantifying physical demands. A basic job description is frequently prepared by the employer, however in certain applications a vocational professional is employed to prepare job descriptions following an analysis of the corresponding job.

While conventional job descriptions provide valuable data for certain uses, they have limitations in efficiently providing needed information in certain circumstances. For example, when a worker suffers an injury or onset of a debilitating condition, their ability to perform the essential job functions can be impaired. This frequently results in a corresponding workers compensation claim and can also partially or completely remove the worker from fulfilling their previous job functions. The complete or partial inability to perform their previous job functions can be temporary or permanent. In many workers compensation claims, the injured and/or debilitated worker will receive evaluation and possible treatment from a treating physician. The treating physician generally evaluates the severity of the worker's injury and/or impairment. The treating physician desirably provides an accurate professional assessment of the worker's abilities and any limitations, particularly with respect to their ability to fully or partially fulfill job requirements. This evaluation is utilized as a factor in assessing the worker's ability to fulfill essential job functions and thus their return to work.

### SUMMARY OF THE INVENTION

A difficulty for the treating physician in accurately assessing the worker's ability to perform given job functions involves limitations in their ability to gather accurate objective information about the particular essential job functions and physical demands of the job held by the injured/impaired worker. For example, while the worker can provide a description of the requirements of their job, this description is inherently subjective and frequently lacking quantitative specificity. In addition, in certain circumstances the motivation for the worker to provide an accurate assessment of their true essential work requirements may be lacking.

A further difficulty is that existing third party objective job descriptions are frequently either lacking in sufficient detail and/or are only inefficiently accessible by the treating physician. For example, a typical written job description may lack sufficient specificity, such as the duration or frequency of required tasks. Description of the corresponding physical demands placed upon the worker can be of insufficient detail to allow the physician to accurately assess whether or not the given worker is capable of fully or at least partially fulfilling these tasks. More comprehensive job descriptions, which may even include video illustration of a representative worker performing a given job, may also lack the required detailed information to allow the treating physician to accurately assess whether or not the given injured/impaired worker is capable performing the essential job functions.

A further limitation of a simple video illustration of a representative worker performing a given job is that the video clip is configured for serial viewing. An interested party, such as a treating physician, may need to sequentially view a significant portion of a serial video clip to view a segment of interest, for example a segment illustrating required lifting tasks when the injured worker suffers limitations in their ability to lift. As treating physicians are frequently highly compensated professionals with significant demands on their time and skills, the inefficiency of scrolling through less relevant data to arrive at portions of more relevant data is an undesirably inefficient use of their time and skill.

A further limitation is that a treating physician, a benefits provider, and even an employer may lack an efficient system for matching the capabilities and any limitations of an injured/impaired worker with available jobs. For example, there may exist the possibility of returning an injured/impaired worker to work under at least temporarily modified job responsibilities. There may further exist alternative jobs with the same employer having different essential job functions which may more closely or even completely match the abilities and/or limitations of the injured/impaired worker that the worker could be reassigned to. However, lacking an efficient system for identifying such possible modifications and/or reassignments, an injured/impaired worker may continue for some time away from useful work when in fact they could be performing an alternative job or at least a modified/restricted version of their preexisting job. Time away from work for an injured/impaired worker is a significant cost both for the employer and benefits providers. Thus it is strongly desired that an injured/impaired worker be returned to work in at least some aspect as soon as admissible for their individual injury/impairment. In addition, more accurate and timely sharing of detailed information relating to the particular job requirements for a particular job would facilitate more efficient use of time and resources of interested parties as well as providing a valuable double check or safeguard against inaccurate or less than fully warranted workers compensation claims.

From the forgoing, it can be appreciated that there is an ongoing need and desire for a system and method for more accurately and efficiently providing detailed information of essential job functions for various jobs. There is also a need and desire for such information to be partitioned and directly accessible in a segmented fashion such that an interested party such as a treating physician can directly access information relating to particular aspects of a job while bypassing aspects of less interest. There is also a desire for sharing of relevant data among interested parties, such that for example a treating physician can provide individual information for a given patient reflecting their individual abilities and limitations for performing given essential job functions. It would be further desired that such access and information sharing be provided in a secured manner to both protect the integrity of the information system as well as to protect confidential information from unauthorized parties. It would also be desirable that such an information system be distributed or remotely accessible such that a plurality of authorized users at different physical locations can timely and efficiently access and share information.

These needs are satisfied by the invention in which certain embodiments include a job analysis database configured to be stored on storage media, wherein the database comprises video and narrative data indicative of job functions of at least one job and wherein the video and narrative data is subdivided and indexed by job function such that at least one user can access one or more portions of the video and narrative data corresponding to job functions of interest.

Another embodiment includes a system providing job analysis data wherein the data includes video illustrations of job tasks and associated narrative description of the job tasks for at least a first job and wherein one or more authorized users can input additional narrative for the at least first job such that the additional narrative is accessible by other authorized users.

A further embodiment comprises a method of providing job analysis data, the method comprising obtaining video images of a representative worker performing job functions of at least one job, measuring quantifiable aspects of the job functions of the at least one job, developing descriptive narrative of the job functions of the at least one job, wherein the descriptive narrative is at least partially based on the measuring, combining the video images and the descriptive narrative into linked data segments, indexing the linked data segments such that a data segment of interest can be directly accessed, and providing access to the indexed linked data segments for at least one user.

Yet another embodiment includes a system for providing job analysis data, the system comprising means for obtaining video images of a representative worker performing job functions of at least one job, means for measuring quantifiable aspects of the job functions of the at least one job, means for developing descriptive narrative of the job functions of the at least one job, wherein the descriptive narrative is at least partially based on the measuring, means for combining the video images and the descriptive narrative into linked data segments, means for indexing the linked data segments such that a data segment of interest can be directly accessed, and means for providing access to the indexed linked data segments for at least one user. These and other objects and advantages of the invention will become more apparent from the following description taken in conjunction with the accompanying drawings.

### BRIEF DESCRIPTION OF THE DRAWINGS

FIG. 1 is a high level block diagram on one embodiment of a video job analysis system;

FIG. 2 is a block diagram of one embodiment of a video job analysis system;

FIG. 3 is a block diagram of one embodiment of a database including analyses of a plurality of jobs;

FIG. 4 is a block diagram of one embodiment of video and narrative data of a job function;

FIG. 5 is an exemplary illustration of one embodiment of a job analysis screen showing various job functions for a given job;

FIG. 6 is an exemplary illustration of one embodiment of additional narrative data regarding selected job functions;

FIG. 7 is an exemplary workflow diagram of one embodiment of a video job analysis system; and

FIG. 8 illustrates one embodiment of revisions that can be indicated for the job functions for a given worker.

### DETAILED DESCRIPTION OF THE PREFERRED EMBODIMENT

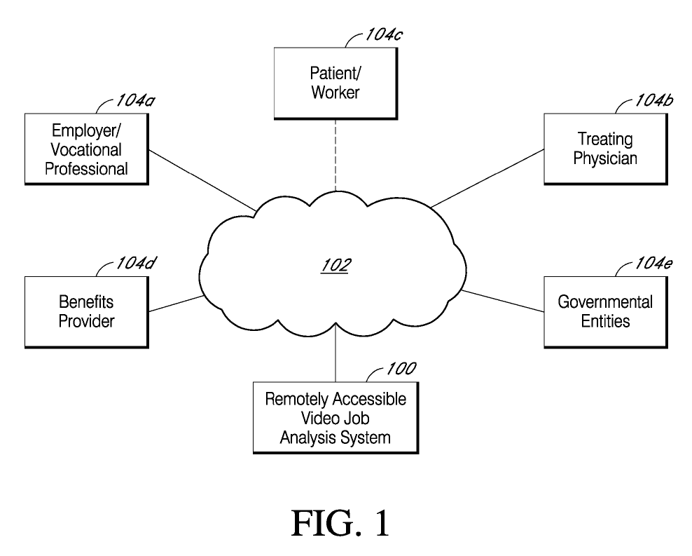

FIG. 1 illustrates a high level block diagram of one embodiment of a remotely accessible video job analysis system 100 which will be hereafter referred to as the system 100 for brevity. The system 100 provides an updatable database providing video and associated narrative description of job functions for one or more jobs. The information provided by the system 100 is further categorized and indexed by particular job functions of the job such that users can search or direct their attention to a desired category of job function or a particular job function of a given job.

The system 100 is in communication with one or more remote access vehicles 102. The remote access vehicle 102 is illustrated schematically in FIG. 1 and in various embodiments can comprise one or more of a local area network (LAN), a wide area network (WAN), and/or the Internet. In other embodiments, the remote access vehicle 102 comprises removable storage which is configured to contain data associated with the system 100 and distributed for remote, portable access by users of the system 100. In certain implementations, the remote access vehicle 102 is preferably configured as a commonly accessible Web-based or Internet access to facilitate more timely updating of information such that users can access more current information from the system 100.

As illustrated in FIG. 1, the system 100 and remote access vehicle 102 is configured such that a plurality of users 104 can access the information of the system 100. In one particular embodiment, these users can include an employer and/or vocational professional 104a, a treating physician or clinic 104b, a patient/worker 104c, one or more benefits providers 104d, and governmental entities 104e. In this embodiment, the employer and/or vocational professionals 104a can provide job analysis data indicative of at least the essential job functions for one or more jobs offered by the employer 104a. The patient/worker 104c can incur a debilitating injury or condition which might limit their ability to fulfill the essential job functions of the job offered by the employer 104a. The patient/worker 104c can be evaluated by the treating physician 104b resulting in an assessment of the patient/worker's 104c physical capabilities and any limitations.

Via the communication with the system 100 provided by the remote access vehicle 102, information relating to both the essential job functions of jobs provided by the employer 104a and the physical capabilities and any limitations of the patient/worker 104c as determined by their evaluation from the treating physician/clinic 104b can be shared among the interested parties. As previously noted, in certain implementations it is preferred that communication with and access to the system 100 be secured, e.g. in a manner that inhibits access by other than authorized users. Implementations of appropriate encryption protocols, password protection, and/or otherwise secured data links will be readily understood by one of ordinary skill in the art.

In one embodiment, one or more benefits providers 104d can similarly access the system 100 via the remote access vehicle 102 to efficiently access data indicative of both the particular requirements of one or more jobs provided by the employer 104a as well as the physical capabilities and any limitations of the patient/worker. Governmental entities 104e, for example judicial bodies and/or social benefits administrations can likewise access in an efficient and timely manner frequently updated information of the system 100 related to the essential job functions of a particular job provided by the employer 104a and the physical capabilities and any limitations of the patient/worker 104c. The secure and remotely accessible information provided by the system 100 greatly facilitates an increased efficiency of utilization of resources among the interest parties 104a-104e. The secured and efficient access provided by the system 100 also facilitates maintenance of utilization integrity of a worker's compensation system to contain costs for the employer 104a and benefits provider 104d, more effective utilization of the valuable time and abilities of the treating physician 104b, return of an injured/impaired worker 104c to gainful employment in a more efficient manner, and reduction in the burden on governmental entities 104e to adjudicate problematic worker's compensation claims. Additional advantages of the system 100 will become apparent following a more detailed description of the information and capabilities of the system 100 as described below.

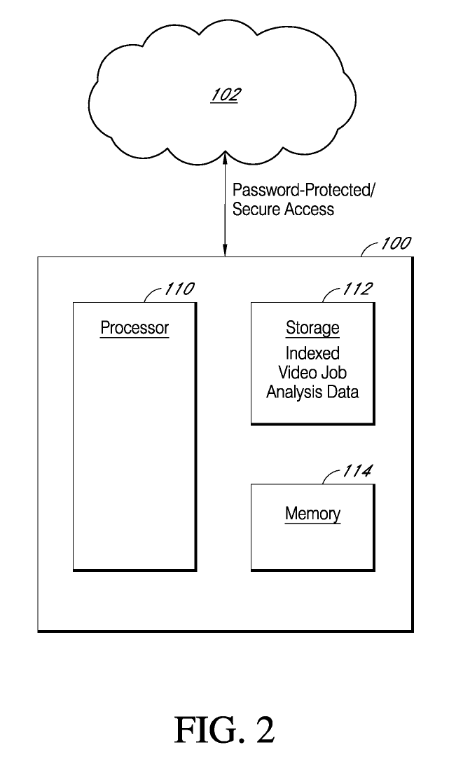

FIG. 2 illustrates a high level block diagram of one embodiment of the system 100 and components thereof. In this embodiment, the system 100 includes a processor 110 that is in communication with storage 112 and memory 114. The system 100 is configured to store and provide to authorized users indexed video job analysis data. In one embodiment, this indexed video job analysis data is stored at a single centralized location and in other embodiments the indexed video job analysis data can be stored and accessed in a distributed manner, for example at localized servers convenient to one or more interested parties 104.

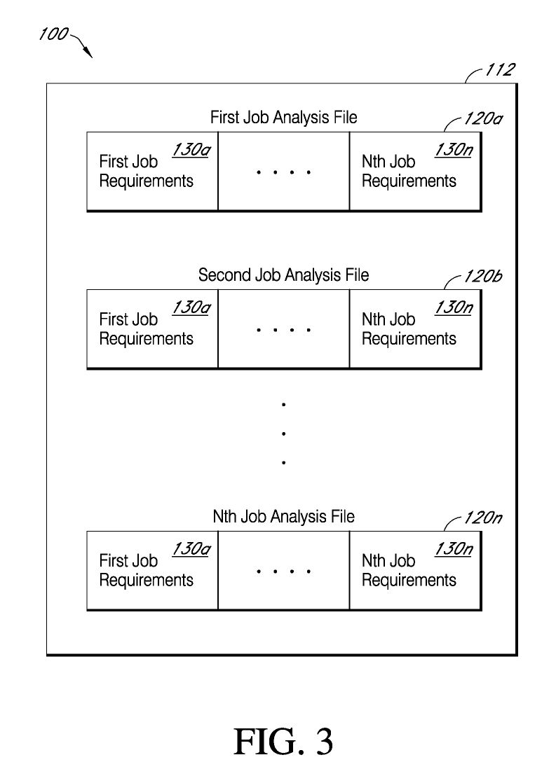

FIG. 3 is a more detailed block diagram illustrating one embodiment of information provided by the indexed video job analysis data. In this embodiment, a plurality of job analysis files 120a, 120b . . . 120n provide job analysis data indicative of the job requirements for associated jobs. Each job analysis file 120 is in this embodiment categorized and indexed by associated job requirements 130. In one embodiment, the one or more job analysis files 120 are subdivided and indexed according to physical job requirements 130. For example, a first job requirement 130a provides data reflective of essential job requirements relating to lifting, and nth job requirement 130n can reflect essential job requirements relating to standing. It will be understood that in certain implementations, one or more of the first through nth job requirements 130a-130n can be null for a given job analysis file 120. For example, one job analysis file 120a may indicate a significant proportion of essential job functions relating to standing whereas a second job analysis file 120b may reflect negligible essential job functions relating to standing.

An advantage provided by embodiments of the system 100 is a sorting or cross-indexing capability as a function of one or more of the first through nth job requirements 130a-130n. For example, a user 104 may indicate that a given patient/worker 104c is capable of standing for no more than one hour per day. The data contained in the system 100 can be sorted or cross-indexed for this limitation and return results of one or more job analysis files 120 satisfying sort criteria. This provides the useful capability to efficiently identify those jobs and corresponding job analysis files 120 which match or at least more closely match the abilities and any limitations of a given worker 104c.

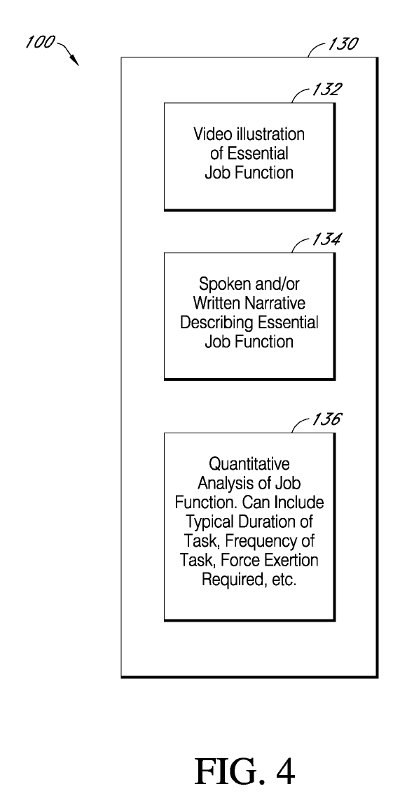

FIG. 4 illustrates in additional detail one embodiment of data provided by the one or more job analysis files 120 for a given job requirement 130. In this embodiment, each data portion indicative of a given job requirement 130 includes a video illustration 132 of at least the associated essential job functions. For example, the video illustration 132 provides a visual depiction of the associated physical activities for the given job requirements. The video illustration 132 can include background scenes of the workplace, an illustration of a typical worker engaged in their usual and customary duties, employing typical workplace tools and instruments, and interacting with typical workplace products, implements, etc. The video illustration 132 can serve the function for the employer/vocational professional 104a of accurately depicting the essential job functions and associated expectations of the respective job. The video illustration 132 also provides useful information to the treating physician 104b in evaluating objective data illustrating a representative worker performing the essential job functions of a given job.

A further advantage is provided by the subdivision and indexing of the data of the system 100. More particularly, a treating physician 104b, for example, can directly access the job requirements 130 for a particular job analysis file 120 for the particular concerns of a given worker. For example, should that worker solely have limitations in lifting above their head, the treating physician 104b can direct their attention directly to the respective job requirements of lifting above the head for the worker's job while skipping over other job requirements 130 of the associated job analysis file 120 which are of less interest and concern for the given worker.

The system 100 and the indexed job requirements 130 thereof also comprise narrative description 134 describing at least the essential job functions. It should be understood that as used herein essential job functions are terms used in the field referring to the regulatory requirements of an employer to provide a job description detailing essential job functions of that job. It will be understood that in certain embodiments, the system 100 provides not only the regulatory required essential job functions but also nonessential job functions and other information in excess of the regulatory requirements for the essential job functions.

The narrative description 134 can include spoken and/or written narrative. For example, in one implementation an indexed portion of a video job analysis provides data for particular job requirements 130 including the video illustration 132 of the associated job functions as well as a spoken/voiceover narrative associated with the video illustration 132. In certain embodiments, written or textual narrative data can be included with the video images of the video illustration 132 either in combination with or as an alternative to spoken/voiceover narrative.

The indexed job requirements 130 of the system 100 also comprise, for at least certain job requirements, 130 a quantitative analysis 136 of job functions. The particular quantitative analysis 136 provided would typically depend on the particular nature of the corresponding job function 130, but in various implementations can include a typical duration of the task, expected/required frequency of performing the task, force exertion required to perform the task, etc. For example, a job requirement 130 associated with lifting can include a quantitative analysis 136 of the typical weights of items which would need to be lifted, a range or height to which they would need to be lifted and a frequency or duration where lifting is required in a given job. In certain preferred embodiments, the quantitative analysis 136 is provided with the assistance of vocational professionals who perform empirical measurements of workers performing the required tasks.

Thus, in certain preferred embodiments, the quantitative analysis 136 is based at least partially on scientific measurements and can thus provide more accurate specific information regarding the actual requirements and demands of a worker performing the respective job functions. The quantitative analysis 136 provided by the system 100 is both objective, detailed and associated with corresponding video illustration 132 such that a user 104, for example a treating physician 104b, can more accurately assess the ability of a given patient/worker 104c to successfully perform required job tasks. The treating physician 104b can also more readily determine whether restrictions or other accommodations in the worker's job placement are indicated based on their individual condition. While FIG. 4 illustrates the quantitative analysis 136 as a separate element from the narrative description 134, in certain embodiments these elements would be combined such that the quantitative analysis 136 is incorporated with other narrative description 132 and associated with corresponding video illustration 132.

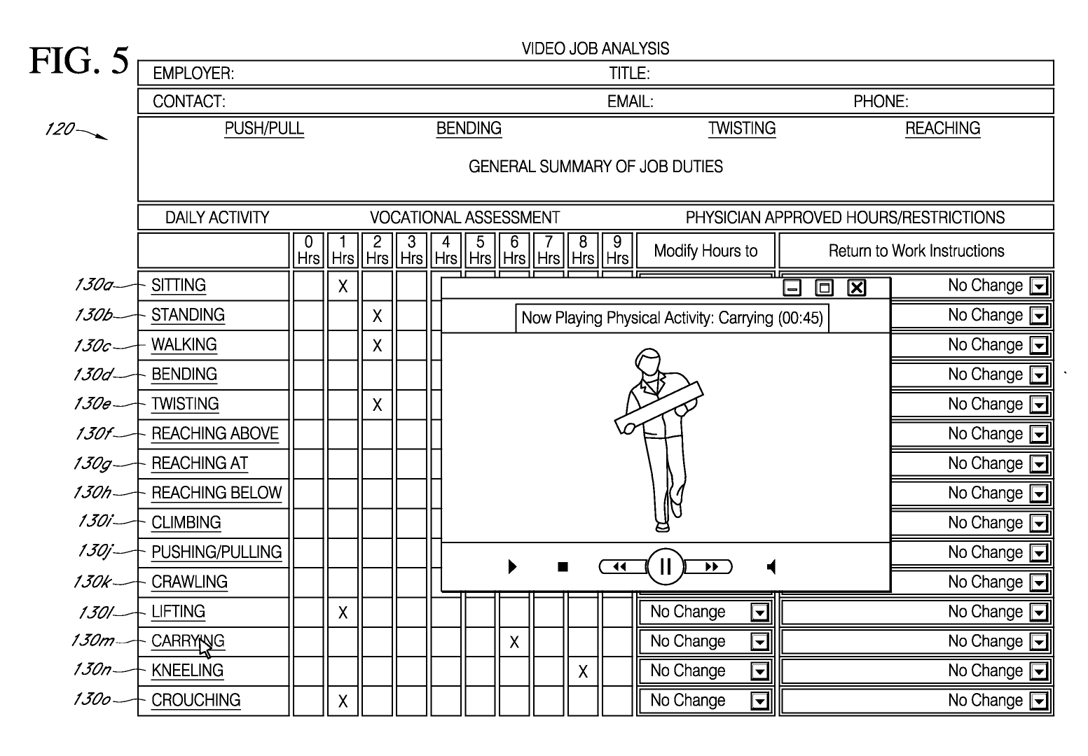

FIG. 5 is an exemplary illustration of one embodiment of data provided by the system 100 to one or more users 104. FIG. 5 illustrates that the system 100 provides, in this embodiment, a job analysis for regular duty for a particular job title, the associated employer and contact information as well as the regular hours per week for the job. The system 100 also provides a written description of job duties and any other requirements/qualifications for the particular job. In this embodiment, the job analysis file 120a also provides a plurality of indexed job requirements 130a-130o detailing the job requirements of sitting 130a, standing 130b, etc. Each job requirement 130 also indicates a frequency of performing the associated physical task which may range from one hour or less for the job requirement of sitting 130a up to two hours for the job requirement of standing 130b.

In one embodiment, the database of the system 100, including the job requirements 130 for at least one job analysis file 120, is configured such that users may remotely access the database for viewing and interaction via personal computers, ultra mobile personal computers (UMPC), etc. In one embodiment, the system 100 is configured such that one or more authorized users 104 can access the data of the system 100 in a secured yet flexible Web-based manner. In one embodiment, a user 104 can select indexed job requirements 130 of interest in a well understood graphical user interface (GUI). For example, should a particular patient/worker 104 suffer an impaired ability to reach overhead, a treating physician 104b can gain secured access to the system 100 and more particularly, the particular job requirements 130f associated with the physical tasks of reaching overhead for a particular job offered by the employer 104a. This information can be readily accessed by authorized users, but access is restricted to protect integrity of the system 100 as well as to protect the confidentiality of, for example, the patient/worker 104c. Upon selecting the job requirement 130f relating to reaching overhead, the system 100 would provide more detailed information to the treating physician 104b. In one embodiment, the data includes a video illustration 132 of a representative worker reaching overhead in context of the associated job as well as associated narrative description 134 which, in this embodiment, includes quantitative analysis 136 of the requirements for the reaching above task.

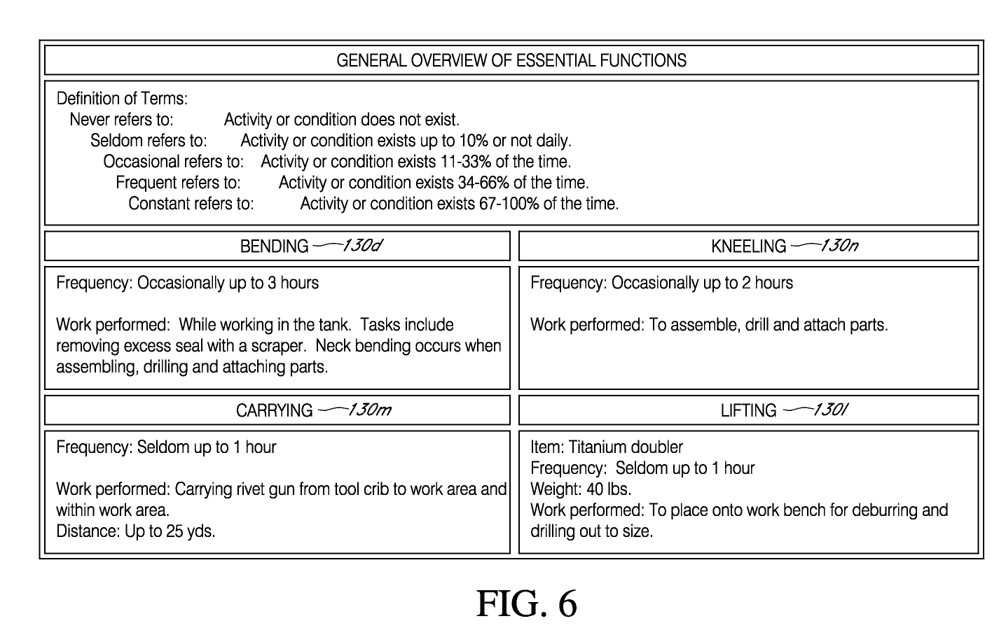

For example, FIG. 6 illustrates one embodiment of additional details of selected job requirements 130 indicated briefly in FIG. 5. For example, the physical activities of bending 130d has associated narrative description 134 and quantitative analysis 136 that the bending activity in general is an occasional activity, e.g. an activity or condition existing between 11 and 33% of the work time. Thus the treating physician 104b can direct their attention directly to job requirements 130 of interest and be provided with both video illustration and narrative details to assist their evaluation of the patient/worker's 104c ability to perform the associated job functions.

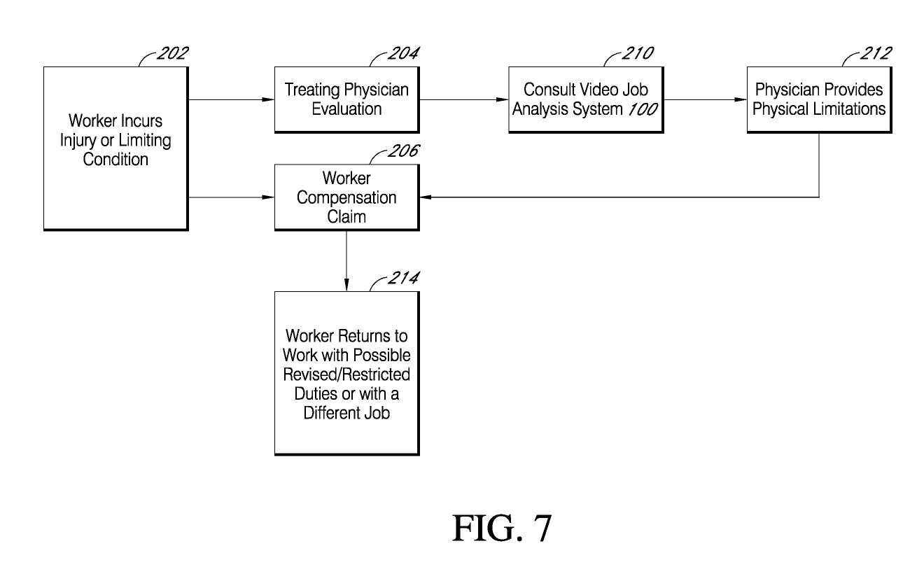

FIG. 7 is an exemplary work flow diagram of certain embodiments employing aspects of the system 100 as previously described. In this embodiment, in a first block 202, a worker incurs an injury or limiting condition which might affect their ability to perform either a job which they currently hold or a potential new job position. In this embodiment, the injury and/or limiting condition incurred by the worker in block 202 results in both an evaluation by a treating physician in block 204 as well as initiation of a worker compensation claim indicated by block 206. In this embodiment, as part of the evaluation process, the treating physician consults the video job analysis system 100 in a block 210. The particular implementations of the consultation of block 210 will depend on the condition of the patient, as well as the nature of the job or jobs in question, however will generally include an evaluation of the essential job requirements 130 provided by the system 100 as well as professional evaluation by the treating physician as to the capability or any limitations of the worker in performing those job functions.

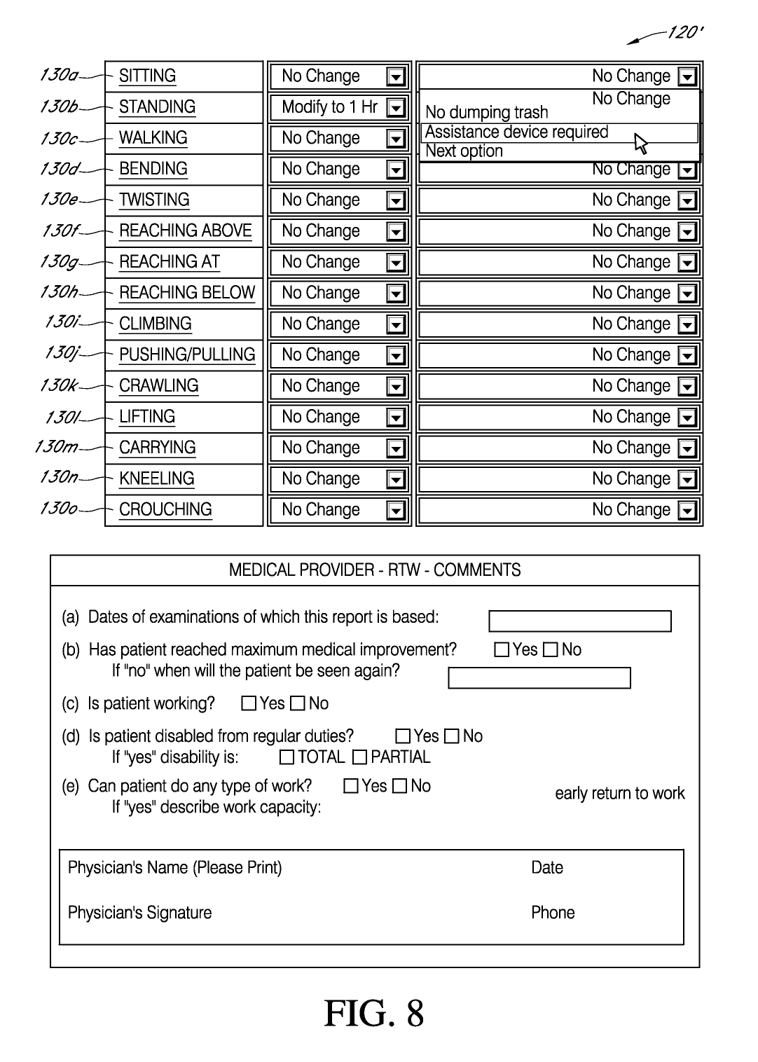

In a block 212, the treating physician provides their evaluation of the patient's physical capabilities and/or limitations and this evaluation is included as part of the worker compensation claim processing. FIG. 8 is an exemplary illustration of one embodiment in which an authorized user, such as a treating physician 104b can provide a revised job analysis file 120′ as part of block 212. In one embodiment, the revised job analysis file 120′ reflects modifications or limitations of the job requirements 120 for the specific needs/capabilities of an individual worker/patient 104c. The revised job analysis file 120′ includes indexed job requirements 130a through 130o as well as user modifiable fields wherein the authorized user can indicate any changes or restrictions to the respective job functions 130. For example, a injured/impaired worker 104c can have a limitation in lifting 1301 such that the treating physician 104b provides a limitation that they lift no more than 5 pounds in weight. As another example, the physician may indicate that standing 130b be limited to no more than one hour per day and that an assistance device is required. The modified job analysis file 120′ for that worker would reflect this limitation for the job requirements 130.

The revised job analysis file 120′ also provides fields wherein the authorized user, such as a treating physician 104b, can provide additional comments and narrative indicative of the worker's ability to return to full, modified, or an alternative job duty. Again, in certain preferred embodiments, access to the system 100 is preferably maintained in a secure manner. Submission of a revised job analysis file 120′ may require an appropriate digital signature certificate, password, and/or appropriate encryption protocols. These aspects maintain the rapid efficient access and interchange of information while maintaining security and integrity of data in the system 100.

As further indicated in FIG. 7, in this embodiment a block 214 results from the worker compensation claim processing of block 206 wherein the worker returns to work with possible revised or restricted duties or with a different job. It will be understood that the return to work of block 214 may follow a recuperative period where the worker recovers full or at least partial ability to fulfill the original essential job functions. It will be further appreciated that the work flow illustrated in FIG. 7 can repeat in an iterative manner, for example where the worker's recuperation proceeds in manner such that their physical capabilities and limitations change over time such that their return to work encompasses multiple revised work duties and/or alternative job placements.

Again, as previously noted the remotely available secured access provided by the system 100 to multiple interested parties or users 104 facilitates implementation of a return to work program for the injured/impaired worker in a manner that facilitates efficient matching of the patient capabilities and limitations with either a revised job duty or an alternative job placement provided by the employer 104a. This provides the advantage to the employer 104a of more rapidly receiving the work benefits of the worker in at least a partial capacity. The system 100 provides the advantage to the treating physician 104b of easily and rapidly accessing detailed objective data indicative of job requirements of jobs provided by the employer 104a with reduced time devoted to reviewing less relevant data. The patient/worker 104c receives the advantage of more efficient utilization of resources to return them to gainful employment subject to their personal limitations and capabilities including with revised work duties or an alternative job placement if indicated. Benefits providers 104d receive the advantage of a more efficient return to work program and cost savings from reduced time away from work for the worker as well as improved utilization of the time and professional services of the treating physician 104b. Governmental entities 104e receive the benefit of the more efficient return to work program having higher integrity and simplification in adjudicating problematic worker's compensation claims.

Although the above disclosed embodiments have shown, described and pointed out novel features of the invention as applied to the above-disclosed embodiments, it should be understood that various omissions, substitutions, and changes in the form of the detail of the devices, systems and/or methods illustrated may be made by those skilled in the art without departing from the scope of the present teachings. Consequently, the scope of the invention should not be limited to the foregoing description but should be defined by the appended claims.

What is claimed is:

1. A job analysis database configured to be stored on storage media, wherein the database comprises video and narrative data indicative of job functions of at least one job and wherein the video and narrative data is subdivided and indexed by job function such that at least one user can access one or more portions of the video and narrative data corresponding to job functions of interest.

2. The database of claim 1, wherein the video and narrative data is indicative of physical requirements of the at least one job.

3. The data base of claim 1, wherein the database includes video and narrative data indicative of job functions of a plurality of jobs and is sortable across selected data for multiple jobs, such that a user can determine those jobs having narrative data matching criteria for one or more subdivisions.

4. The database of claim 1, wherein the narrative data comprises quantitative analysis of the job functions.

5. The database of claim 4, wherein the quantitative data comprises force exertion required.

6. The database of claim 4, wherein the quantitative analysis comprises frequencies of job functions in the at least one job.

7. The database of claim 1, wherein the database comprises a first set of predefined narrative data for the at least one job and a corresponding second user modifiable set of narrative data.

8. The database of claim 1, wherein the narrative data comprises at least one of spoken and written narrative data.

9. The database of claim 1, wherein the database is further configured to be remotely accessed by the at least one user.

10. A system providing job analysis data wherein the data includes video illustrations of job tasks and associated narrative description of the job tasks for at least a first job and wherein one or more authorized users can input additional narrative for the at least first job such that the additional narrative is accessible by other authorized users.

11. The system of claim 10, wherein the data can be remotely accessed.

12. The system of claim 11, wherein the remote access is configured such that unauthorized access is inhibited.

13. The system of claim 11, wherein the remote access comprises at least one of access via a local area network, a wide area network, and the Internet.

14. The system of claim 10, wherein the data is indicative of physical job tasks for the at least first job.

15. The system of claim 14, wherein a first authorized user comprises medical personnel and wherein the additional narrative comprises at least one of physical capabilities and physical limitations for a worker having the at least first job.

16. The system of claim 15, wherein a second authorized user comprises an employer of the worker and wherein modified job tasks of the at least first job can be defined for the worker, if the physical capabilities or physical limitations of the worker do not match essential job tasks.

17. The system of claim 15, wherein a second authorized user comprises an employer of the worker and wherein a second job can be matched with the worker, if the physical capabilities or physical limitations of the worker do not match essential job functions of the first job.

18. A method of providing job analysis data, the method comprising:
obtaining video images of a representative worker performing job functions of at least one job;
measuring quantifiable aspects of the job functions of the at least one job;
developing descriptive narrative of the job functions of the at least one job, wherein the descriptive narrative is at least partially based on the measuring;
combining the video images and the descriptive narrative into linked data segments;
indexing the linked data segments such that a data segment of interest can be directly accessed; and
providing access to the indexed linked data segments for at least one user.

19. The method of claim 18, wherein the measuring comprises measuring at least one of time duration and force required to perform job functions.

20. A system for providing job analysis data, the system comprising:
means for obtaining video images of a representative worker performing job functions of at least one job;
means for measuring quantifiable aspects of the job functions of the at least one job;
means for developing descriptive narrative of the job functions of the at least one job, wherein the descriptive narrative is at least partially based on the measuring;
means for combining the video images and the descriptive narrative into linked data segments;
means for indexing the linked data segments such that a data segment of interest can be directly accessed; and
means for providing access to the indexed linked data segments for at least one user.
